(19) United States
(12) Patent Application Publication
(10) Pub. No.: US 2026/0246610 A1
(43) Pub. Date: Aug. 20, 2026

(54) SFTP COMMAND FILTER FOR ACCESS CONTROL ON AN HSM

(71) Applicant: THALES DIS CPL USA, INC., Austin, TX (US)

(72) Inventor: Braden HAYES, Ottawa (CA)

(73) Assignee: THALES DIS CPL USA, INC., Austin, TX (US)

(21) Appl. No.: 19/054,982

(22) Filed: Feb. 17, 2025

(51) Int. Cl. H04L 9/06; H04L 9/40

(52) U.S. Cl. CPC H04L 9/0631; H04L 63/0428; H04L 63/166

(57) ABSTRACT

Provided is a solution for filtering and controlling SFTP commands in operating systems while addressing security concerns arising from the deprecation of older file transfer protocols. Embodiments are directed to a system, method and device. A Hardware Security Module comprises a Secure Shell Daemon (111), an SFTP Command Filter (112) and an SFTP Server (113). In some embodiments the a SFTP Command Filter for decoding and interpreting an encoded SFTP command (30) to determine its operational extent on the HSM, and then comparing it to an allowed list of SFTP Command operations on the HSM, and either allowing or disallowing process piping of the SFTP Command to an SFTP Server based on the comparing. Other embodiments are disclosed.

### TECHNICAL FIELD

The present invention relates generally to data communication across computer networks, and more particularly, to secure file transfer over a secure connection with a Hardware Security Module (HSM) using the Secure File Transfer protocol (SFTP).

### BACKGROUND

A Hardware Security Module (HSM) is a physical device that stores and manages cryptographic keys. HSMs are used to protect sensitive information, such as digital signatures, authentication credentials, and cryptographic artifacts. They act as trust anchors that protect the cryptographic infrastructure by securely managing, processing, and storing cryptographic keys inside a hardened, tamper-resistant device. HSMs safeguard enterprise cryptographic operations including encryption, decryption, authentication, and digital signing by securely managing keys and providing cryptographic services across applications.

An HSM usually includes management utilities and programs to oversee data and file access to sensitive data and files thereon. Files need to be transferred to and from the HSM for various reasons, for example, to update software and firmware via code package updates, or upload and renew certificates to establish secure connections with clients and log servers. Secure Copy Protocol (SCP) is one such utility available on an HSM for safely transferring computer files between a local host and a remote host. SCP is a file transfer network protocol that uses Secure Shell (SSH) mechanisms to ensure data confidentiality. It is generally considered secure though it has been vulnerable to security flaws recently. SCP has been deprecated due to security vulnerabilities, no standardization, limited functionality and poor error handling

SFTP (Secure File Transfer Protocol) is another type of secure file transfer protocol that provides file access, transfer, and management over a secure connection. However, implementing SFTP on existing HSMs configured to support SCP and SSH presents challenges. SFTP is available as an efficient and secure file transfer in many operational environments. However, its implementation on an HSM threatens the HSM's core security model. The HSM is designed to provide a secure environment for cryptographic operations and key management, but introducing SFTP without proper access controls can create a significant security vulnerability. This creates a tension between meeting operational needs and maintaining the high-security standards expected of an HSM.

For example, all users on the HSM, or those with access to a networked based HSM, have root-level access, and this grants unrestricted privileges to all files and directories. This grants unrestricted privileges to all files and directories. If SFTP is implemented without additional controls, it would expose the entire file system of the HSM to all direct users of the HSM and networked users of HSMs. This means any user could potentially access, modify, or delete sensitive cryptographic materials, configuration files, and system logs, thereby compromising the fundamental security principles of the HSM. Secondly, implementing SFTP without proper access control can introduce significant security vulnerabilities.

Additionally, SFTP is a more complex utility compared to SCP that requires a more challenging implementation on an HSM. A fundamental challenge lies in balancing the need for modern file transfer capabilities with the stringent security requirements of an HSM. This requires finding a way to implement SFTP that provides the necessary functionality without compromising the security model of the HSM. It involves reconciling the need for efficient operations with the imperative to protect sensitive cryptographic materials and maintain the integrity of the HSM.

A need therefore exists to integrate SFTP on an HSM, and moreover, in a secure manner that suitably addresses these access controls concerns.

### SUMMARY

Provided is a solution for selectively filtering and controlling SFTP commands in Unix-like operating systems while addressing security concerns arising from the deprecation of older file transfer protocols.

The solution implements a fine-grained access control layer that intercepts all SFTP commands before they reach the file system of the HSM OS. This control layer acts as a security barrier, effectively negating the risks associated with root-level access, wherein all SFTP operations are filtered through this control layer, regardless of the user's system-level privileges. This control layer enforces strict permissions based on predefined rules, preventing unauthorized access to sensitive areas of the file system. This layered approach maintains the existing user management structure while adding a crucial security layer for SFTP operations. The solution is specifically designed for SFTP operations regardless of the underlying system's user privilege model. It intercepts every encoded SFTP command before it reaches the sftp-server process and checks it against an allow list and specific access rules. Allowed commands are passed to the sftp-server, while all other commands are blocked.

To balance HSM security and functionality issue, the solution allows SFTP functionality but with strict controls by way of implementing the allow list of essential SFTP commands. These commands enable basic file transfer operations while preventing potentially dangerous actions. Additional allowed commands support necessary SFTP session management. To balance the HSM principle of least privilege issue, the solution enforces least privilege for SFTP operations despite the root-level access of all users. Access is granted on a per-command and per-file basis, not based on the user's system-level privileges. Each SFTP request is evaluated against predefined access rules, allowing operations only on permitted files and directories. This granular control ensures users can only perform actions necessary for their specific roles, even if their system account has root access.

In some embodiments, a Hardware Security Module (HSM) appliance (10) is provided to manage administrative services with a remote SFTP Client (120), wherein the HSM comprises a Secure Shell Daemon (SSHD) (111) and an SFTP Server (113). The Secure Shell Daemon (SSHD) (111) can be for intercepting an encrypted request from the SFTP Client (120) over an SSH communication channel (117); decrypting the encrypted request to produce an encoded SFTP Command; forwarding the encoded SFTP Command to an SFTP Command Filter (112); the SFTP Command Filter (112) communicatively coupled to the SSHD (111) for decoding the encoded SFTP command (30) to produce an SFTP Command; interpreting the SFTP Command to determine its operational extent on the HSM; comparing the operational extent to an allowed list of SFTP Command operations, or actual textual representations of the command, on the HSM; allowing process piping of the SFTP Command to an SFTP Server (113) and forwarding an actual response from the SFTP Server (113) when the comparing identifies an allowed SFTP command; and disallowing process piping of the SFTP Command to the SFTP Server (113) and injecting an artificial response not from the SFTP Server (113) when the comparing identifies a disallowed SFTP command. The SFTP Server (113) is communicatively coupled to the SFTP Command Filter (112) for receiving and responding to only an allowed SFTP command (31) from the SFTP Client (120) via process piping from the SFTP Command Filter (112), thereby restricting direct process piping between the SSHD (111) and SFTP Server (113) for the disallowed SFTP command (32).

In some embodiments, the interpreting evaluates READ, WRITE and EXECUTE operations of the SFTP Command on the HSM responsive to the SSHD decrypting the encrypted request, and, wherein the operational extent comprises file access, file permissions and file privileges on directory structures on the HSM.

In some embodiments, the SFTP Command Filter (112) evaluates each and every encoded SFTP Command individually, and does not analyze packet headers associated with encrypted data and does not block or allow entire SFTP connections.

In some embodiments, the SFTP Command Filter (112) operates at Application Layer 1 of the Open Systems Interconnect (OSI) model for interpreting and filtering individual SFTP commands after decryption by the SSHD without need for an end-to-end connection between the SFTP Client Application (120) and SFTP Server (113) instead of the Network Layer 3 and Transport Layer 4 where firewalls operate at the packet and frame rate of an end-to-end connection between the SFTP Client Application (120) and the SSHD.

In some embodiments, the SFTP Command Filter (112) resolves ASCII or Binary format related to encoding and decoding the SFTP commands (107), and the SSHD (111) uses Advanced Encryption Standard (AES) to encrypt and decrypt the encoded SFTP commands (108) over the SSH communication channel, wherein the SFTP Command Filter (112) automatically determines a text and character encoding for transferring SFTP commands over the SSH communication channel.

In some embodiments, the HSM can further comprise a Crypto API Client (156) that via an in-band Transport Layer Security (TLS) communication channel to the HSM processes cryptographic requests and responses with encrypted and decrypted data responsive to the SFTP Command Filter (112) logging a certificate related encoded allowed SFTP command.

In some embodiments, the SFTP Command Filter (112) responds to the SSHD with the artificial response if the operational extent of the SFTP command is not allowed for a specific virtual HSM (vHSM) therein, and consequently does not engage with the SFTP Server, thereby blocking disallowed SFTP (32) commands from the process piping; and the SFTP Server responds to the SSHD with the actual response if the operational extent of the SFTP command is allowed for the specific virtual HSM (vHSM) therein and consequently forwards allowed SFTP commands (31) from the SFTP Server via the process piping.

In some embodiments, a method for a Hardware Security Module (HSM) appliance (10) to manage administrative services with a remote SFTP Client (120). By way of a Secure Shell Daemon (SSHD) (111) the method comprises intercepting an encrypted request from the SFTP Client (120) over an SSH communication channel (117); decrypting the encrypted request to produce an encoded SFTP Command; forwarding the encoded SFTP Command to an SFTP Command Filter (112). By way of the SFTP Command Filter (112) communicatively coupled to the SSHD (111), the method comprises decoding the encoded SFTP command (30) to produce an SFTP Command; interpreting the SFTP Command to determine its operational extent on the HSM; and comparing the operational extent to an allowed list of SFTP Command operations on the HSM; allowing process piping of the SFTP Command to an SFTP Server (113) and forwarding an actual response from the SFTP Server (13) when the comparing identifies an allowed SFTP command; and disallowing process piping of the SFTP Command to the SFTP Server (113) and injecting an artificial response not from the SFTP Server (13) when the comparing identifies a disallowed SFTP command. By way of the SFTP Server (113) communicatively coupled to the SFTP Command Filter, the method comprises receiving and responding to only an allowed SFTP command (31) from the SFTP Client (120) via process piping from the SFTP Command Filter (112), thereby restricting direct process piping between the SSHD (111) and SFTP Server (113) for the disallowed SFTP command (32).

In some embodiments, the interpreting evaluates READ, WRITE and EXECUTE operations of the SFTP Command on the HSM responsive to the SSHD decrypting the encrypted request, and wherein the operational extent comprises file access, file permissions and file privileges on directory structures on the HSM.

In some embodiments, by way of the SFTP Command Filter (112), the method comprises responding to the SSHD with the artificial response if the operational extent of the SFTP command is not allowed for a specific virtual HSM (vHSM) therein, and consequently does not engage with the SFTP Server, thereby blocking disallowed SFTP (32) commands from the process piping; and, by way of the SFTP Server, responding to the SSHD with the actual response if the operational extent of the SFTP command is allowed for the specific virtual HSM (vHSM) therein and consequently forwards allowed SFTP commands (31) from the SFTP Server via the process piping.

In some embodiments, the HSM further comprises a Crypto API Client (156) that via an in-band Transport Layer Security (TLS) communication channel to the HSM processes cryptographic requests and responses with encrypted and decrypted data responsive to the SFTP Command Filter (112) logging a certificate related encoded allowed SFTP command.

In some embodiments, an SFTP Client (120) is provided to manage administrative services with a remote Hardware Security Module (HSM) (10), wherein the HSM appliance (10) comprises a main processor hosting an Operating System (OS) that runs a Secure Shell Daemon (SSHD) (111), an SFTP Command Filter (112) and an an SFTP Server (113). The Secure Shell Daemon (SSHD) (111) can provide for intercepting an encrypted request from the SFTP Client (120) over an SSH communication channel (117); decrypting the encrypted request to produce an encoded SFTP Command; and forwarding the encoded SFTP Command to an SFTP Command Filter (112). The SFTP Command Filter (112) can be communicatively coupled to the SSHD (111) for decoding the encoded SFTP command (30) to produce an SFTP Command; interpreting the SFTP Command to determine its operational extent on the HSM; comparing the operational extent to an allowed list of SFTP Command operations on the HSM; allowing process piping of the SFTP Command to an SFTP Server (113) and forwarding an actual response from the SFTP Server (13) when the comparing identifies an allowed SFTP command; and disallowing process piping of the SFTP Command to the SFTP Server (113) and injecting an artificial response not from the SFTP Server (13) when the comparing identifies a disallowed SFTP command. The SFTP Server (113) can be communicatively coupled to the SFTP Command Filter (112) for receiving and responding to only an allowed SFTP command (31) from the SFTP Client (120) via process piping from the SFTP Command Filter (112), thereby restricting direct process piping between the SSHD (111) and SFTP Server (113) for the disallowed SFTP command (32).

In some embodiments, the interpreting evaluates READ, WRITE and EXECUTE operations of the SFTP Command on the HSM responsive to the SSHD decrypting the encrypted request, and, wherein the operational extent comprises file access, file permissions and file privileges on directory structures on the HSM.

In some embodiments, the SFTP Client can provide for receiving the artificial response from the SFTP Command Filter (112) when the operational extent of the SFTP command is not allowed for a specific virtual HSM (vHSM) therein, and consequently does not engage with the SFTP Server, thereby blocking disallowed SFTP (32) commands from the process piping; andreceiving the actual response form the SFTP Server when the operational extent of the SFTP command is allowed for the specific virtual HSM (vHSM) therein and consequently forwards allowed SFTP commands (31) from the SFTP Server via the process piping.

In some embodiments, the SFTP Client complements a Crypto API Client (156) that via an in-band Transport Layer Security (TLS) communication channel to the HSM processes cryptographic requests and responses with encrypted and decrypted data responsive to the SFTP Command Filter (112) logging a certificate related encoded allowed SFTP command.

### BRIEF DESCRIPTION OF THE DRAWINGS

The accompanying drawings, which are incorporated in and constitute a part of this description, illustrate embodiments consistent with the invention and, together with the description, serve to explain the principles of the invention.

FIG. 1 depicts an exemplary communication system for safeguarding and securing data over the Internet and into the cloud in accordance with some embodiments;

FIG. 2A depicts an exemplary SFTP command filtering session using secure file transfer between the HSM and device over an SSH communication channel in accordance with some embodiments;

FIG. 2B depicts a sequence diagram of a method to manage administrative services with an SFTP Client via SFTP over an SSH communication channel in accordance with some embodiments;

FIG. 3 depicts a cryptographic processing environment that handles both HSM administrative services with an SFTP Client and HSM cryptographic services with a Crypto API Client in accordance with some embodiments; and

FIG. 4 depicts exemplary components of a Hardware Server Module (HSM) 10.
Specific embodiments in this invention have been shown by way of example in the foregoing drawings and are hereinafter described in detail. The figures and written description are not intended to limit the scope of the inventive concepts in any manner. Rather, they are provided to illustrate the inventive concepts to a person skilled in the art by reference to particular embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

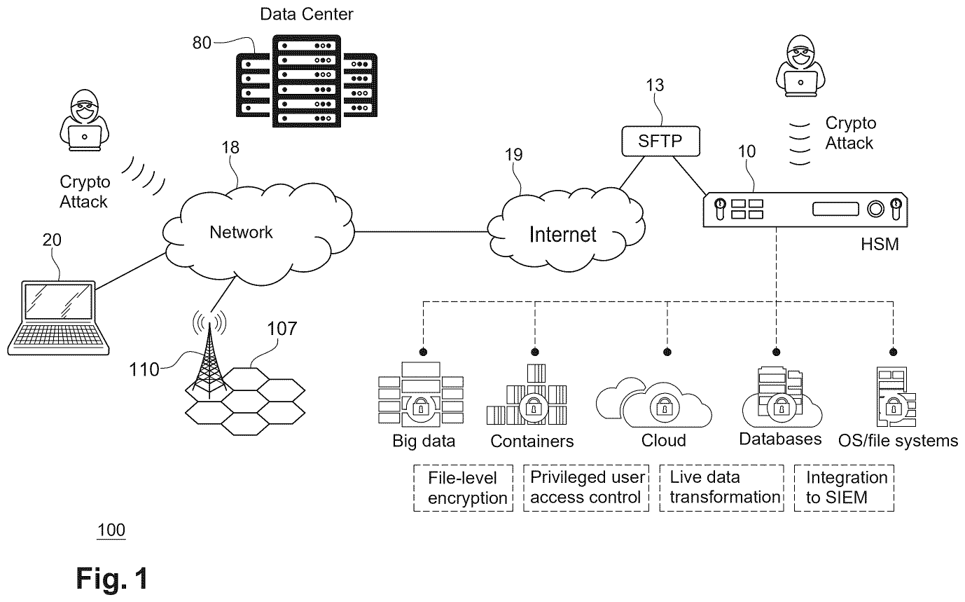

FIG. 1 depicts an exemplary communication system 100 for safeguarding and securing data from crypto attacks as it moves from networks and applications over the Internet and into the cloud. The system 100 integrates centralized key management with data protection and granular access controls. It discovers and classifies sensitive data, combats external threats, guards against insider abuse, and establishes persistent controls, even when data is stored in the cloud or in any external provider's infrastructure for on-prem and cloud-based data. In support of key lifecycle management, hardware and virtual appliances are leveraged, which are communicatively coupled to system components.

The system 100 includes a Hardware Security Module (HSM) 10 to secure sensitive data across changing environments and increasing threats. The HSM 10 provides secure management of sensitive data, such as keys, which can be configured as a root of trust for the system and for verifying chains of key encryption keys. It is one component of a trust data security platform to protect and control an organization's sensitive data, for example, related to Big Data, Containers, Cloud, Databases and Operating System (OS) File Servers. It increases data security, accelerates time to compliance, secures cloud migration, delivers data-at-rest encryption, privileged user access controls and detailed data access audit logging among other features.

As a security hardened unit, the HSM 10 records tamper evidence, such as visible signs of tampering or logging and alerting, and provides for tamper responsiveness such as deleting keys upon tamper detection. The HSM provides local and remote management features tailored to the HSM 10. Secure connections with HSMs over the Network 18 and Internet 19 can be established in conjunction with utilizing smart card access control. On this point, the HSM includes a management utility to support Secure File Transfer Protocol (SFTP) 13 for secure transfer of data associated with many HSM administrative functions, including, but not limited to, the commissioning, provisioning, configuring, deploying and maintenance of the HSM 10. SFTP provides file access, transfer, and management over a secure connection as shown.

The HSM 10 may reside in a networked data center 80 for providing cloud HSM services via one or more Payments HSM instances. In such deployment, it can provide for Software as a Service (SaaS), Platform as a Service (PaaS), or Infrastructure as a Service (IaaS) models. It may also form part of an HSM cluster managed by a single server application used by various services and applications. These cloud-based and network-attached HSMs can be used by a large number of clients/tenants. In such arrangements, the HSM 10 is configured to allow for multi-tenancy deployment in a Hardware-as-a-Service model (HaaS) where it is shared by multiple customers.

The system 100 includes a telecommunication network 18 and an internet communication network (Internet) 19. The telecom network provides a mobile communication link via base receiver 110 for wireless connectivity of mobile devices from one or more cells 107. Devices 20 can also connect to the Network 18 or Internet 19 over a Wireless Local Access Network (WLAN) or Wi-Fi respectively. WLANs provide wireless access to the mobile communication environment within a local geographical area. WLANs can also complement loading on a cellular system, so as to increase capacity. Wi-Fi is the wireless technology used to connect computers, tablets, smartphones and other devices to the internet.

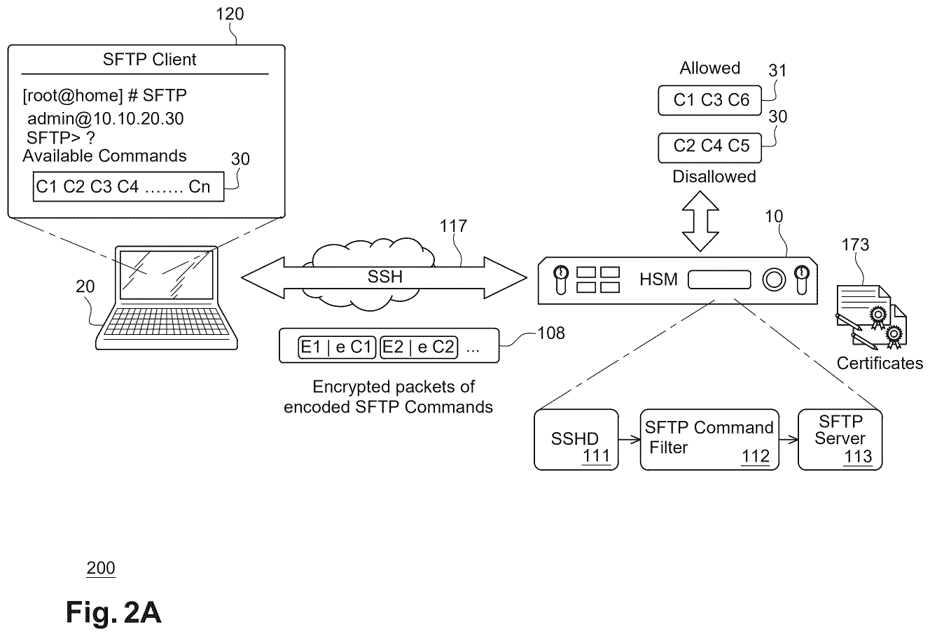

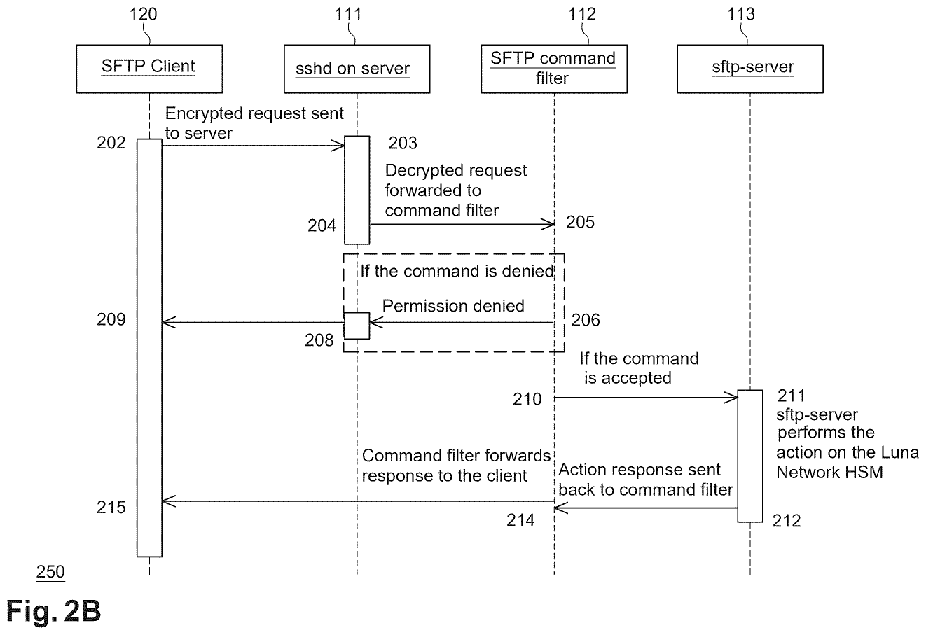

FIG. 2A depicts an exemplary SFTP command filtering session using secure file transfer between the HSM 10 and device 20, which are communicatively coupled over an SSH communication channel 117. The SSHD 111 in the HSM is a process daemon thereon that listens for incoming Secure Shell (SSH) connections and manages the resulting connection. It handles user authentication, key exchange, and encryption/decryption of data transmitted to and from the SFTP Client 120. The SFTP Server 113 executes on the HSM to allow secure file transfer with the HSM 10, and uses a standard sftp-server distribution that leverages well-tested components. In normal deployments, the SFTP Server 113 listens for connections on ports assigned to the Secure Shell (SSH) protocol, for example, port 22 via the SSHD 111. This port is a virtual communication endpoint that acts as a designated entry point for incoming data, thereby allowing the SFTP Client 120 to connect to the HSM and issue SFTP commands to the HSM.

Here, the SFTP Command Filter 112 is inserted between the SSH 111 and the SFTP Server 113 modules to intercept encoded SFTP Commands and associated data from the SSHD 111 before reaching the SFTP Server 113. In this software interface architecture, the SFTP Command Filter 112 provides an additional control layer to the SFTP Server 113. Accordingly, it is an actual endpoint for message exchange terminations with the SFTP Client 120 that believes it is interfacing directly to the SFTP server 113. The SFTP Client 120 is the other actual endpoint and executes on the device 20, which may be a laptop or remote workstation, for commissioning, provisioning, configuring, deploying, managing or maintaining the HSM 10.

The SFTP Client 120 may be, for example, a Linux command shell, or other Unix-like shell depending on the HSM host Operating System (OS). Similarly, the SFTP client could be Windows too or any implementation of an SFTP client. As illustrated, the opening command “sftp username@ip_address” is used to establish a connection to the SFTP Server 113, where “username” is the user's name, such as “admin”, to use on the SFTP Server 113, and the IP address or hostname is that of the SFTP Server 113. Depending on the HSM configuration, a password or other simple authentication may also be required for SSH. In other configurations, or in addition to, the HSM may require a certificate based authentication to ensure that the HSM is suitable for protecting sensitive data and processing cryptographic commands. To this point, the HSM may include a FIPS 140-3 certified security boundary therein that validates the effectiveness of its cryptographic hardware.

Most SSH deployments with an HSM use some form of public key authentication, which uses asymmetric cryptography with a public/private key pair generated for each user and host to authenticate themselves. To this point, the HSM 10 will include one or more manufacturer, or self-signed, certificates 173 that are embedded into a secure memory during manufacture, or during a warranting process in a secure facility, thereby allowing others to validate that the HSM has met certain security standards. Users or administrators of the HSM may also have their own assigned certificates 173 for their roles on the HSM.

Understandably, allowing an SFTP Client 120 to delete or replace these certificates 173 by way of a standard SFTP command is a concern. This is because users could unintentionally, or maliciously, harm the HSM system files, file directories, and so on. For example, once the SSH connection is established to the SFTP Server 113, the SFTP Client 120 can proceed to issue any and all SFTP commands to the HSM. Common sftp commands on the HSM, such as a PUT command to upload file, GET command to download file, LS command to list files, CHMOD to change permissions, MKDIR to create a directory, RMDIR to delete a directory, RM to remove files, and so on. A standard SFTP implementation gives users unrestricted privilege to all the files and directories.

Accordingly, the SFTP Command Filter 112 decides what commands are allowed and everything else is automatically disallowed. The SFTP Command Filter 112 sits between the SSH 111 and the SFTP Server 113 modules to intercept encoded SFTP Commands and associated data. It interfaces to both the modules but does not allow either to be aware of its presence as to the commands it filters in (allows) or filters out (disallows). Thus, for example, where a standard SFTP shell permits for commands 30 C1, C2, C3, C4, etc. as shown, certain SFTP commands such as C1 (PUT), C3 (GET) and C6 (LS) are allowed commands 31 and will be processed by the HSM, but other SFTP commands C2(MKDIR), C4 (RMDIR) and C5 (CHMOD) are not allowed by the HSM; namely, are allowed commands 32.

Allowed SFTP commands 31 are generally those that allow a customer or client of the HSM to transfer data to and from the HSM for their particular need, for example, to update firmware or replace certificates. Disallowed SFTP commands 32 are those that could compromise the security or functionality of the HSM, for example, those that remove/create critical directories or delete/modify certificates, or SFTP commands that expose operational data otherwise they should not have access to, such as, system logs or audit information. The SFTP Command Filter 112 effectively wraps SFTP with proper access controls at the application layer to mitigate the aforementioned security vulnerabilities, as there is no available solution otherwise to simply restrict users to the files and directories they need for their specific roles at the OS level. Here, file-level access controls are enforced, restricting operations to predetermined safe directories and files.

FIG. 2B depicts a sequence diagram of a method 250 for an HSM to manage administrative services with an SFTP Client via SFTP over an SSH communication channel. The HSM appliance 10 comprises a main processor (see FIG. 4) hosting an Operating System (OS) that runs a Secure Shell Daemon (SSHD) 111, an SFTP Command Filter 112 communicatively coupled to the SSHD 111, and an SFTP Server 113 communicatively coupled to the SFTP Command Filter 112.

The method can start at step 202, where the SFTP Client Application 120 sends an encrypted request to the SSHD 110. Briefly, “encrypting/decrypting” in this context is related to SSHD activities associated with securely transmitting data packets over the SSH connection 117. As one example, SFTP Client 120 and SSHD 111 may agree to use Advanced Encryption Standard (AES) to encrypt and decrypt data communications over the SSH communication channel 117. The encrypted request will contain one or more encoded SFTP commands and associated data.

Upon receipt, at step 203, the SSHD 111 decrypts the encrypted request to produce one or more encoded SFTP commands and associated data at step 204. As example, it may decrypt it using Advanced Encryption Standard (AES). Here also, the term encode is associated with SFTP command formatting; it is distinct from “encrypting/decrypting” related to SSH data packet transmission of the prior step.

At step 204, the SSHD 111 forwards the decrypted request to the SFTP command filter. Briefly, whereas the SSHD would usually connect to and then open a process pipe directly to the SFTP Server 113, here, for example, by way of a pointer manipulation therein according to one embodiment, the SSHD opens the process pipe instead to the SFTP Command Filter 112, which serves as a proxy for receiving the forwarded packets in the connection on behalf of the SFTP Server 113.

The process pipe is a temporary, unidirectional communication channel that allows one process to send data to another process, thereby acting as a virtual file where the output of one program becomes the input of another, enabling data flow between them without needing to store it on disk. As a proxy, the SFTP Command Filter 112 technically spawns a sub-process being the actual SFTP Server 113 still along the same process pipe that the SSHD would have originally opened up after connection, and then puts back and forth any traffic. The sub-process sits as a process running on the HSM itself, and is not outside the HSM.

At step 205, the SFTP Command Filter 112 receives from the SSHD 111 the decrypted request; namely, the encoded SFTP command. Notably, on receipt, it is still encoded with SFTP formatting, and thus needs to be decoded. As one example, UTF-8 is a Unicode encoding that allows for the accurate transfer of characters across different systems. The SFTP Command Filter 112 may also employ auto-detect option to automatically determine the appropriate encoding based on the file content of the decrypted request. It resolves Binary or ASCII formats related to encoding and decoding the SFTP commands (107), or other text and character encoding associated with transferring SFTP commands over the SSH communication channel.

At step 206, the SFTP Command Filter 112 decodes the encoded SFTP command 30 to produce an SFTP Command. It then interprets the SFTP Command to determine an operational extent on the HSM. This may also include identifying a user role and whether command execution is required with elevated system privileges This interpreting step may also include, for example, evaluating READ, WRITE and EXECUTE operations of the SFTP Command on the HSM. It then compares the operational extent to an allowed list of SFTP Command operations on the HSM. The operational extent may include, for example, file access (e.g. RW, R, W, EXE), file permissions (e.g. 644, 755, etc.) and/or file privileges on directory structures on the HSM associated with the system level commands (e.g. read, write, execute) or combinations thereof. The interpretating may include comparing to actual string representations of the command, for example, “CHMOD”, “RW”,“W” and so on.

File permissions settings may be numeric, for example: 777 where all users can read/write/execute the file; 755 where an owner can do all, group/others can read/execute; or 644 where owner can read/write, group/others can read only. It can directly compare the SFTP command to allowed SFTP commands (31) in the allow list as a first measure for approval/disapproval of its use. Additionally, it indirectly compares the operational extent to parameters associated with the operational extent of allowed/disallowed commands as a second measure for allowed/disallowed use. As an example, it may compare R, W, E values or numeric values, such as, 644, 775, etc.

Here, the SFTP Command Filter 112 evaluates each and every encoded SFTP Command individually. It does not analyze packet headers associated with encrypted data and does not block or allow entire SFTP connections as does a firewall. On this point, the SFTP Command Filter 112 operates at Application Layer 1 of the Open Systems Interconnect (OSI) model for interpreting and filtering individual SFTP commands after decryption by the SSHD without need for an end-to-end connection between the SFTP Client Application 110 and SFTP Server 113, instead of the Network Layer 3 and Transport Layer 4 where firewalls operate at the packet and frame rate of an end-to-end connection between the SFTP Client Application 110 and the SSHD 111.

At step 208, if the SFTP Command Filter 112 determines the command is disapproved and/or disallowed, the SFTP Command Filter 112 disallows process piping of the SFTP Command to the SFTP Server 113, and instead injects an artificial response to the SSHD 111. The reply to the SSHD is “artificial” because it is not an actual response from the SFTP Server 113. Rather, the SFTP Command Filter 112 re-wraps and bundles back its own response to the SSHD to inform it in a manner as would be expected from the SFTP-Server 113.

The SSHD 111 then replies back to the SFTP Client 120 that the command is not available at step 208. The response sent back to the SFTP client also will be decrypted through SSH by the device 20 running the SFTP client 120. Here too, the SFTP Client 120 believes the response was from the the SFTP-Server 113; it is not aware it is an artificial reply. Also, the SFTP Command Filter 112 actively logs denied operations for audit purpose to enhance security monitoring, including in some examples, the disallowed SFTP command and operational extent related to file access, directories and data.

In contrast, at step 210, if the SFTP Command Filter 112 determines the command is approved and/or allowed, it allows process piping of the SFTP Command to the SFTP Server 113. Here, for example, it may permit continuous data transmission off the opened process pipe from the SSHD 111 to the SFTP Server 113 for the existing data packets associated with the allowed SFTP command; in some embodiments, it does need not assemble data packets.

At step 211, with the command is accepted, the SFTP Server 113 proceeds to process the SFTP command on the HSM 10 as it normally would. The SFTP Server 113 replies back to the SFTP Command Filter 112 at step 212 with an actual response.

At step 214, the SFTP Command Filter 112 then forwards this actual response from the SFTP Server 113 directly to the SFTP Client 120. Notably, the SSHD 111 is not engaged when the command is accepted. Accordingly, it does not inform the SFTP Client 120 that the command is available, as would occur when the command is denied. The data packets will be transmitted to the SFTP Client 120 over the opened process pipe directly from the SFTP Server 113.

The SFTP Client 120 receives the forwarded actual response from the SFTP Server 113 at step 215. This also results in an expected command behavior as observed by the SFTP Client 120; since it is not aware of the SFTP Command Filter 112.

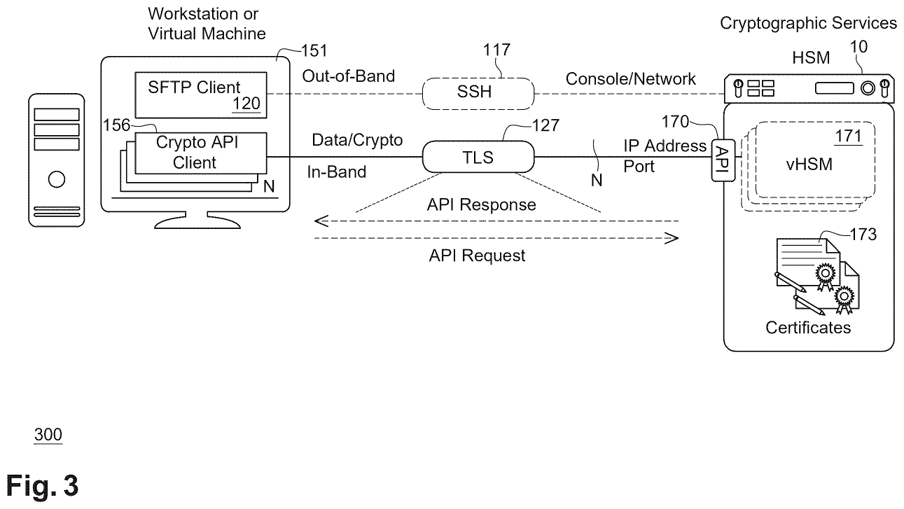

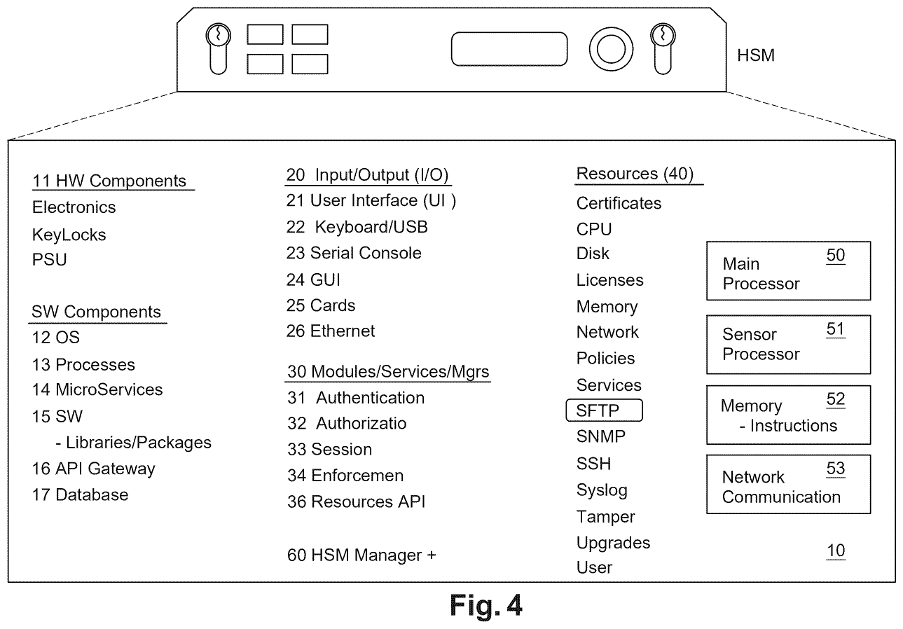

FIG. 3 depicts a cryptographic processing environment 300 that handles both HSM administrative services with an SFTP Client 120, and HSM cryptographic services with a Crypto API Client (156).

In this illustration the workstation (or virtual machine) 151 is an Administrative Client, for example, an HSM Clientor HSM Manager®, that contains the SFTP Client 120. It is used to manage the HSM 101 over a secure 117 communication channel using SFTP commands. This process for selectively filtering in allowed and filtering out disallowed SFTP commands was described in FIG. 1.

The workstation 151 additionally hosts one or more Crypto API Clients 156 for generating cryptographic service requests with the HSM 10. These are software applications that run thereon and invoke the API 170 to interface to the HSM 10. A resulting cryptographic service request may be, but not limited to, data encryption/decryption, key generation/management, and/or PKI actions (signing, verification, etc.) among others. The Crypto API Clients 156 communicate with the HSM over a secure TCP/TLS communication channel 127 for handling the cryptographic services, commands and data.

Briefly, the in-band communication channel 127 for TLS protocol with the Crypto API Client 156 is distinct from the out-of-band communication channel 117 for SSH protocol with the SFTP Client 120. Both SSH and TLS are security protocols used to encrypt data transmission, though SSH operates independently and has its own encryption mechanisms; it does not directly utilize the TLS protocol itself. Here, “In-band” refers to the ability to signal administrative services within each cryptographic API, in contrast to “out-of-band” mechanisms that might include separate connections to process cryptographic service requests with different bandwidth and performance needs. This in-band connection may also terminate like the out-of-band channel on an Internet Protocol (IP) address and port; albeit a different HSM port number and address.

In this exemplary embodiment, there is considered the non-limiting example of a cloud-based (web-based) system architecture, wherein one or more virtualized HSMs are housed in a data center and is accessible/configurable by users, or an API, through the Internet as a communication network. Here, the HSM 10 instantiates one or more virtual HSMs (vHSMs) 171 using virtualization technologies such as containers or micro VMs. It configures, manages and orchestrates these virtual HSM instances for each tenant thereon and their corresponding client applications; namely, with the SFTP Client 120 for HSM administrative services, and the Crypto API Client 156 for HSM cryptographic services. Each vHSM instance is provided with necessary keys and certificates 173 for secure communications and for creating an authenticated sessions with an application.

To this point, the SFTP Client 120 is able to configure, update and install these various certificates 173 on the HSM, specific to each vHSM as needed for TLS and SSH connections. Accordingly, various encoded SFTP commands related to certificate 173 access and use are allowed via the allow list previously described to handle certificate management across multiple vHSMs on the same HSM. Some of these allowed SFTP commands consider various factors related to the operational extent, for example, but not limited to, configuring or assigning the number of tenant vHSMs allowed, the bandwidth usage per vHSM, performance balancing of cryptographic requests between tenants, and so on. In such configuration, the HSM processes cryptographic requests and responses with encrypted and decrypted data responsive to the SFTP Command Filter 112 logging a certificate related action by way of an allowed encoded SFTP command. Upon the SFTP Command Filter 112 logging this certificate related action, and confirmation that the certificates are installed, the HSM proceeds with HSM cryptographic services as shown.

As an example, different vHSMs may handle SFTP commands differently according to use-case licenses, for example, vHSMs with Transaction Per Second (TPS) limits for cryptographic operations, or associated performance constraints and allowances. In these cases, the SFTP Command Filter (112) does respond to the SSHD with the artificial response if the operational extent of the SFTP command is not allowed for a specific virtual HSM (vHSM) therein, and consequently does not engage with the SFTP Server, thereby blocking disallowed SFTP (32) commands from the process piping; and

does respond to the SSHD with the actual response if the operational extent of the SFTP command is allowed for the specific virtual HSM (vHSM) therein and consequently does engage with the SFTP Server to process the SFTP command, thereby forwarding allowed SFTP commands (31) from the SFTP Server via the process piping.

FIG. 4 depicts exemplary components of a Hardware Server Module (HSM) 10. The HSM 10 is a physical computing device that, among other capabilities, safeguards and manages digital keys, performs encryption and decryption functions for digital signatures, and provides for strong authentication and other cryptographic functions. It may exist in the form of a PCI plug-in card or an external hardware rack unit that attaches directly to a computer or network server within a data center. As a security hardened unit, the HSM 10 records tamper evidence, such as visible signs of tampering or logging and alerting, and provides for tamper responsiveness such as deleting keys upon tamper detection. The HSM 10 contains one or more secure crypto processor and sensor chips to prevent tampering and bus probing, or a combination of chips in a module that is protected by the tamper evident, tamper resistant, or tamper responsive packaging.

Operational use of the HSM 10 is primarily by way of the components shown in the figure, but understandably, many more components, electronics, and modules are present in a typical HSM. Those components shown are those mostly related, and suitable for use, for implementing the foregoing inventive methods. Hardware (HW) components 11 represent general electronics for operating the HSM (e.g., processors, central processing units, security, sensors, memory, network devices, ports, power supply units (PSU), wires, keylocks, etc.). The Hardware also contains memory to run operating system and input-output (I/O) devices for interaction. It comprises different types of processors, such as a crypto processor, sensor processor, general processing unit (GPU), central processing unit (CPU) to assist in protection, management of keys and hardware acceleration with the operating system. The keys, or any other data, can be stored in the database for persistence. The hardware architecture is designed to protect and manage digital keys, and can perform encryption, decryption, digital signature generation and verification.

The Operating System (OS) 12 is a software component that executes on top of hardware, for example, the general processor, to manage hardware resources and peripherals, run HSM jobs/processes, and help in execution of other processes 13. Ubuntu is an exemplary OS that provides an embedded Linux distribution with libraries and packages. Ubuntu (GNU/Linux) is a multitasking Operating System capable of executing several processes (tasks) simultaneously. Different processes 13 for performing the HSM functions (data protection, key management, pin translations, etc.) are scheduled by the operating system 12. A thread is the basic unit to which the operating system allocates processor time. A process 13 is an instance of a computer program that is executed by one or many threads in the GPU or CPU. One or more threads run in the context of the process. A thread can execute any part of the process code, including parts currently being executed by another thread.

Certain HSM functionality and capabilities are configured as micro-services. Micro-services are independent and lightweight processes designed to perform specific tasks. They are typically handled and managed within the HSM by way of the OS 12. Micro-services 14 can communicate with each other and with external systems over specialized protocols and application programming interface (API) 16. Micro services are built using software libraries/packages 15, which are a self-contained set of independent and interchangeable software component that implement a specific functionality. Micro-services 14 and Processes 13 are built using these software libraries/packages 15. By way of these microservices, applications can implement a third-party Microservice provider's generic API to a service to deliver HSM capabilities. In this manner, for example, a 3^{rd} party customer by way of APIs can partition their workload to optimized HSMs for performing specific tasks (e.g. ECC/RSA key gen, message signing, etc.) according to their microservice model.

The Applications Programming Interface (API) gateway 16 provides a connection between computers or between computer programs/applications, and/or between computers and people. It is a type of software interface, offering a service to other pieces of software. The API provides a communication channel between HSM components, internal processes 13 and/or micro services 14. These APIs are exposed on top of input/output (I/O) 20 interfaces. External systems and/or people communicate with HSM via the I/O interfaces 20, such as user interface (UI) 21. The HSM can also communicate with external systems through hardware IO interfaces, such as the keyboard 22, serial port 23, Ethernet, optical ports, USB ports, etc. External systems (host computers in a data center) can also talk to HSM software interface via APIs exposed on top of individual hardware interfaces (e.g., network device driver, disk/memory management, etc.)

In some embodiments an electronic hardware sub-system within the HSM 10 provides tamper response against physical and logical attacks against the HSM. The electronic hardware sub-system comprises a Main Processor (MP) 50 running an operating system (OS) that produces virtualized HSM instances (vHSMs) per tenant using virtualization technologies that are one among containers or micro Virtual Machines (uVMs) running crypto services logic; a Sensor Processor (SP) 51 communicatively coupled to said MP over a PCIe communication channel to provide tamper handling against physical and logical attacks of said virtualized HSM instances on said HSM; and an HSM Partition Manager 60 executing in said MP to manage and orchestrate said vHSMs for the aforementioned operations. The MP 50 and SP 51 are distinct hardware devices that each can include one or more Central Processing Units (CPUs) and memory coupled to the one or more CPUs where the memory includes computer instructions which when executed by the one or more processors causes the one or more processors to perform the operations above (e.g., key splitting, key sharing, object memory management, etc.), and as related to fraud analysis, threat detection, and tamper management.

The HSM 10 includes a local console 23 that is serial connected over e.g., a USB-C interface. The serial interface can be used by operations personnel, namely operators, referred to as DCOps (standing for Data Center Operations), who have physical access to the HSM for manually issuing commands to the HSM. Such USB-C interface is used, according to the standing state of the art, for all configuration throughout the HSM service, including initial configuration and cumbersome provisioning processes. The HSM also includes managerial Graphical User Interface (GUI) 24 that over an Ethernet 26 connection allow for remote configuration of the HSM. Also, the I/O 20 can be used to configure network settings, SSH certificates, upgrades, licenses and devices (e.g. CPU, Disk, memory, etc.). Operator (Java) cards 25 also provide a means for provisioning and securing the HSM using key shares and key splits.

The HSM also includes services 30 by way of modules, processes and service managers. Some services may be internal to the HSM, and others may be selectively exposed via the API gateway 16 to external entities or services. Examples of services 30 include authentication 31, authorization 32, session manager 33, enforcement 34, resource API manager 36, and HSM Manager 60, where the + (plus sign) denotes inclusion of other components previously described in the HSM. Accordingly, service managers can be invoked/managed/configured remotely (external) via their APIs, for example, from a web based GUI (e.g. Crypto Command Center) via Internet connection over Ethernet to the HSM 10.

The HSM also includes (internal) resources 40 which can be externally configured via the normal I/O interfaces 20, and also, for some, (internally and externally) via any of the module/service managers 30 and their respective APIs. Examples of HSM resources include, but are not limited to, certificates, licenses, policies, device management, services, upgrades and so on. Each resource 40 has a respective API for software modules, processes or microservices to interact with the respective resource. The HSM offers access and services to each resource 40 via the resources API 36. Aside from HSM related tasks (e.g. encryption/decryption, key management, etc.), this includes: certificate/license management, SNMP, SSH, SFTP 113, memory control, network management/configuration, upgrade installations/services, user resources, and so on.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Scheme, Go, C++, C #, VB. NET, Python or the like, conventional procedural programming languages, such as the “C” programming language, Perl, PHP, dynamic programming languages such as Python, Ruby and Groovy, or other programming languages. The program code may execute entirely on the user's computer, partly on the user's computer, as a stand-alone software package, partly on the user's computer and partly on a remote computer, entirely on the remote computer or server, or within the Cloud or other computer network. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS), Platform as a Service (PaaS) for connecting mobile apps to cloud based services, and Security as a Service (SECaas).

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

What is claimed is:

1. A Hardware Security Module (HSM) appliance (10) to manage administrative services with a remote SFTP Client (120), wherein the HSM comprises:
a Secure Shell Daemon (SSHD) (111) for
intercepting an encrypted request from the SFTP Client (120) over an SSH communication channel (117);
decrypting the encrypted request to produce an encoded SFTP Command;
forwarding the encoded SFTP Command to an SFTP Command Filter (112);
the SFTP Command Filter (112) communicatively coupled to the SSHD (111) for
decoding the encoded SFTP command (30) to produce an SFTP Command;
interpreting the SFTP Command to determine its operational extent on the HSM;
comparing the operational extent to an allowed list of SFTP Command operations on the HSM;
allowing process piping of the SFTP Command to an SFTP Server (113) and forwarding an actual response from the SFTP Server (113) when the comparing identifies an allowed SFTP command; and
disallowing process piping of the SFTP Command to the SFTP Server (113) and injecting an artificial response not from the SFTP Server (113) when the comparing identifies a disallowed SFTP command,
the SFTP Server (113) communicatively coupled to the SFTP Command Filter (112) for receiving and responding to only an allowed SFTP command (31) from the SFTP Client (120) via process piping from the SFTP Command Filter (112), thereby restricting direct process piping between the SSHD (111) and SFTP Server (113) for the disallowed SFTP command (32).

2. The HSM of claim 1, wherein the interpreting evaluates READ, WRITE and EXECUTE operations of the SFTP Command on the HSM responsive to the SSHD decrypting the encrypted request, and, wherein the operational extent comprises file access, file permissions and file privileges on directory structures on the HSM.

3. The HSM of claim 1, wherein the SFTP Command Filter (112) evaluates each and every encoded SFTP Command individually, and does not analyze packet headers associated with encrypted data and does not block or allow entire SFTP connections.

4. The HSM of claim 1, wherein the SFTP Command Filter (112) operates at Application Layer 1 of the Open Systems Interconnect (OSI) model for interpreting and filtering individual SFTP commands after decryption by the SSHD without need for an end-to-end connection between the SFTP Client Application (120) and SFTP Server (113) instead of the Network Layer 3 and Transport Layer 4 where firewalls operate at the packet and frame rate of an end-to-end connection between the SFTP Client Application (120) and the SSHD (111).

5. The HSM of claim 1, wherein
the SFTP Command Filter (112) resolves ASCII or Binary format related to encoding and decoding the SFTP commands (107), and
the SSHD (111) uses Advanced Encryption Standard (AES) to encrypt and decrypt the encoded SFTP commands (108) over the SSH communication channel,
wherein the SFTP Command Filter (112) automatically determines a text and character encoding for transferring SFTP commands over the SSH communication channel.

6. The HSM of claim 1, further comprising a Crypto API Client (156) that via an in-band Transport Layer Security (TLS) communication channel to the HSM processes cryptographic requests and responses with encrypted and decrypted data responsive to the SFTP Command Filter (112) logging a certificate related encoded allowed SFTP command.

7. The HSM of claim 1, wherein
the SFTP Command Filter (112) responds to the SSHD with the artificial response if the operational extent of the SFTP command is not allowed for a specific virtual HSM (vHSM) therein, and consequently does not engage with the SFTP Server, thereby blocking disallowed SFTP (32) commands from the process piping; and
the SFTP Server responds to the SSHD with the actual response if the operational extent of the SFTP command is allowed for the specific virtual HSM (vHSM) therein and consequently forwards allowed SFTP commands (31) from the SFTP Server via the process piping.

8. A method for a Hardware Security Module (HSM) appliance (10) to manage administrative services with a remote SFTP Client (120), the method comprising:
by way of a Secure Shell Daemon (SSHD) (111):
intercepting an encrypted request from the SFTP Client (120) over an SSH communication channel (117);
decrypting the encrypted request to produce an encoded SFTP Command;
forwarding the encoded SFTP Command to an SFTP Command Filter (112);
by way of the SFTP Command Filter (112) communicatively coupled to the SSHD (111):
decoding the encoded SFTP command (30) to produce an SFTP Command;
interpreting the SFTP Command to determine its operational extent on the HSM;
comparing the operational extent to an allowed list of SFTP Command operations on the HSM;
allowing process piping of the SFTP Command to an SFTP Server (113) and forwarding an actual response from the SFTP Server (13) when the comparing identifies an allowed SFTP command; and
disallowing process piping of the SFTP Command to the SFTP Server (113) and injecting an artificial response not from the SFTP Server (13) when the comparing identifies a disallowed SFTP command,
by way of the SFTP Server (113) communicatively coupled to the SFTP Command Filter: receiving and responding to only an allowed SFTP command (31) from the SFTP Client (120) via process piping from the SFTP Command Filter (112), thereby restricting direct process piping between the SSHD (111) and SFTP Server (113) for the disallowed SFTP command (32).

9. The method of claim 8, wherein the interpreting evaluates READ, WRITE and EXECUTE operations of the SFTP Command on the HSM responsive to the SSHD decrypting the encrypted request, and wherein the operational extent comprises file access, file permissions and file privileges on directory structures on the HSM.

10. The method of claim 8, comprising
by way of the SFTP Command Filter (112), responding to the SSHD with the artificial response if the operational extent of the SFTP command is not allowed for a specific virtual HSM (vHSM) therein, and consequently does not engage with the SFTP Server, thereby blocking disallowed SFTP (32) commands from the process piping; and
by way of the SFTP Server, responding to the SSHD with the actual response if the operational extent of the SFTP command is allowed for the specific virtual HSM (vHSM) therein and consequently forwards allowed SFTP commands (31) from the SFTP Server via the process piping.

11. The HSM of claim 8, further comprising a Crypto API Client (156) that via an in-band Transport Layer Security (TLS) communication channel to the HSM processes cryptographic requests and responses with encrypted and decrypted data responsive to the SFTP Command Filter (112) logging a certificate related encoded allowed SFTP command.

12. An SFTP Client (120) to manage administrative services with a remote Hardware Security Module (HSM) (10),
wherein the HSM appliance (10) comprises a main processor hosting an Operating System (OS) that runs:
a Secure Shell Daemon (SSHD) (111) for
intercepting an encrypted request from the SFTP Client (120) over an SSH communication channel (117);
decrypting the encrypted request to produce an encoded SFTP Command;
forwarding the encoded SFTP Command to an SFTP Command Filter (112);
the SFTP Command Filter (112) communicatively coupled to the SSHD (111) for
decoding the encoded SFTP command (30) to produce an SFTP Command;
interpreting the SFTP Command to determine its operational extent on the HSM;
comparing the operational extent to an allowed list of SFTP Command operations on the HSM;
allowing process piping of the SFTP Command to an SFTP Server (113) and forwarding an actual response from the SFTP Server (13) when the comparing identifies an allowed SFTP command; and
disallowing process piping of the SFTP Command to the SFTP Server (113) and injecting an artificial response not from the SFTP Server (13) when the comparing identifies a disallowed SFTP command,
the SFTP Server (113) communicatively coupled to the SFTP Command Filter (112) for receiving and responding to only an allowed SFTP command (31) from the SFTP Client (120) via process piping from the SFTP Command Filter (112), thereby restricting direct process piping between the SSHD (111) and SFTP Server (113) for the disallowed SFTP command (32).

13. The SFTP Client of claim 12, wherein the interpreting evaluates READ, WRITE and EXECUTE operations of the SFTP Command on the HSM responsive to the SSHD decrypting the encrypted request, and, wherein the operational extent comprises file access, file permissions and file privileges on directory structures on the HSM.

14. The SFTP Client of claim 8, comprising
receiving the artificial response from the SFTP Command Filter (112) when the operational extent of the SFTP command is not allowed for a specific virtual HSM (vHSM) therein, and consequently does not engage with the SFTP Server, thereby blocking disallowed SFTP (32) commands from the process piping; and
receiving the actual response form the SFTP Server when the operational extent of the SFTP command is allowed for the specific virtual HSM (vHSM) therein and consequently forwards allowed SFTP commands (31) from the SFTP Server via the process piping.

15. The SFTP Client of claim 8, further complements a Crypto API Client (156) that via an in-band Transport Layer Security (TLS) communication channel to the HSM processes cryptographic requests and responses with encrypted and decrypted data responsive to the SFTP Command Filter (112) logging a certificate related encoded allowed SFTP command.
